(19) United States
(12) Patent Application Publication
(10) Pub. No.: US 2004/0208169 A1
(43) Pub. Date: Oct. 21, 2004

(54) Digital audio signal compression method and apparatus

(76) Inventor: Yuriy A. Reznik, Seattle, WA (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/826,469

(22) Filed: Apr. 16, 2004

Related U.S. Application Data
(60) Provisional application No. 60/464,068, filed on Apr. 18, 2003.

(51) Int. Cl. G06F 15/00; H04L 12/66

(52) U.S. Cl. 370/352; 704/200

(57) ABSTRACT

Compression, of audio signal data is described herein. In various embodiments, the compression of each unit of the audio signal data includes the employment of a distribution substantially representative of residual data generated by a prediction filter applied to the unit of audio signal data, to reduce the amount of data having to be transmitted to transmit the unit of audio signal data to a recipient.

### RELATED APPLICATION

This is a non-provisional application of U.S. provisional application 60/464,068, filed Apr. 18, 2003, entitled “Noiseless Compression of PCM Audio Signals”. This non-provisional application claims priority to said '068 provisional application.

### FIELD OF THE INVENTION

The present invention relates to the field of signal processing. More specifically, the present invention relates to compression of audio signal data.

### BACKGROUND OF THE INVENTION

Digital audio has a number of advantages over analog audio. In particular, pulse code modulation (PCM) audio has a number of advantages over other audio formats. For example, digital audio, in particular, PCM audio, offers freedom to interchange audio data without generation loss between media. Increasingly, PCM audio is not only being offered from medium like compact disc (CD), it is also widely employed in broadcast programming, through air waves or cable, or in streamed contents, through private and/or public networks, such as the Internet.

For broadcast programming or streamed contents, bandwidth availability/consumption remains a significant challenge.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a method view for compressing audio signal data, in accordance with some embodiments of the present invention; and

FIG. 2 illustrates a system, including its transmit and receive sections, in accordance with some embodiments.

### DETAILED DESCRIPTION OF ILLUSTRATIVE EMBODIMENTS

Illustrative embodiments of the present invention include, but are not limited to, method to compress digital audio data (in particular, PCM audio data), encoders/decoders adapted to practice all or portions of the method, and systems having the encoders/decoders.

In the description to follow, for ease of understanding, the present invention will primarily be described in the context of PCM audio embodiments, however, the present invention may be practiced for other digital audio, e.g. one-bit oversampled audio representations commonly used in super-audio compact disks (SACD).

Various aspects of embodiments of the present invention will be described. However, various embodiments may be practiced with only some or all of the described aspects. For purposes of explanation, specific numbers, materials and configurations are set forth in order to provide a thorough understanding of the embodiments being described. In alternate embodiments, they may be practiced without the specific details. In various instances, well-known features are omitted or simplified in order not to obscure the essence of the embodiments.

Parts of the description will be presented in signal processing terms, such as data, filtering, quantization, encoding, decoding, and so forth, consistent with the manner commonly employed by those skilled in the art to convey the substance of their work to others skilled in the art. As well understood by those skilled in the art, the data quantities take the form of electrical, magnetic, or optical signals capable of being stored, transferred, combined, and otherwise manipulated through mechanical, electrical and/or optical components of a general/special purpose computing device/system.

The term “computing device/system” as used herein includes general purpose as well as special purpose data processing machines, systems, and the like, that are standalone, adjunct or embedded. Examples of general purpose “computing devices/systems” include, but are not limited to, handheld computing devices (palm sized, tablet sized and so forth), laptop computing devices, desktop computing devices, servers, and so forth. Examples of special purpose “computing device/system” include, but are not limited to, processor based wireless mobile phones, handheld digital music players, set-top boxes, game boxes/consoles, CD/DVD players, digital cameras, digital CAMCORDERs, and so forth. [DVD—Digital Versatile Disk]

Various operations will be described as multiple discrete operations in turn, in a manner that is most helpful in understanding the various embodiments of the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising”, “having” and “including” are synonymous, unless the context dictates otherwise.

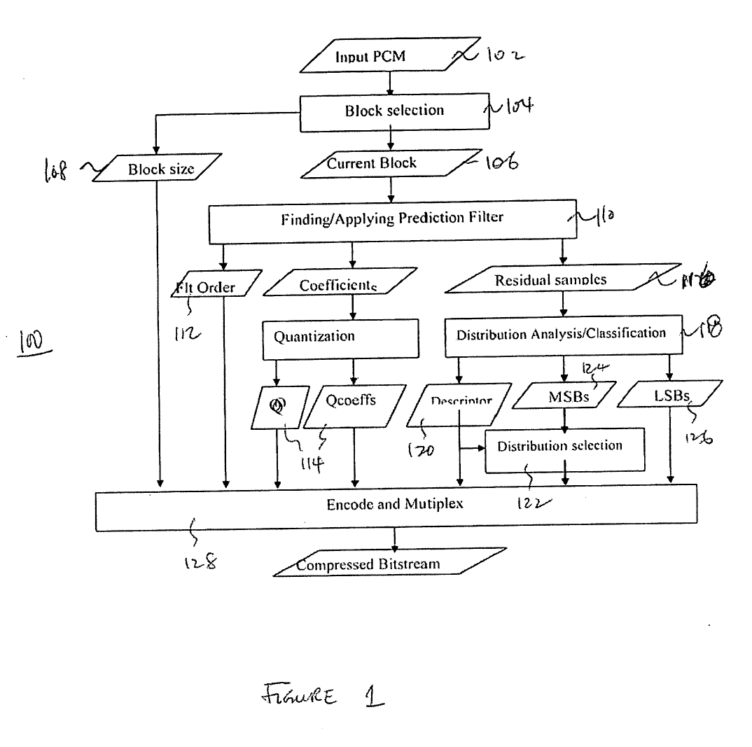

Referring now to FIG. 1, wherein a method view of the present invention, in accordance with some embodiments, is illustrated. As illustrated, for the embodiments, the process 100 starts with the receiving 102 of a portion of a stream of audio signal data (e.g. PCM audio signal data). On receipt, or shortly thereafter, the audio signal data is partitioned 104 into a number of data blocks for subsequent processing (compression). In various embodiments, the audio signal data is partitioned 104 into a number of fixed or variable size data blocks, and when variable sized-blocks are used, the variable data block sizes are conveyed 108 to the recipient (e.g. multiplexed 128 onto the transmission bit stream). For the embodiments, the default fixed data block size is assumed to be known to the recipient, however, in other embodiments, the invention may nonetheless be practiced including the conveyance of the fixed data block size to the recipient (e.g. multiplexed 128 onto the transmission bit stream).

For the embodiments, the data blocks are selected 106 one block at a time, and the remaining operations of process 100 are applied to the currently selected data block to process and compress the data block, and ultimately, after compression, placing 128 the processed/compressed data onto the transmission bit stream for transmission to a recipient. The operations are repeated until all data blocks of the received portion of the audio signal have been processed (compressed), and multiplexed 128 onto the transmission bit stream.

In alternate embodiments, each data block may be further partitioned into sub-blocks, with the sub-blocks being selected for processing (compression) and multiplexed 128 onto the transmission bit stream, one sub-block at a time. Likewise, for these embodiments, the sub-block size may be fixed or variable. Regardless, the sub-block size is conveyed to a recipient. For these embodiments, the operations are also repeated until all sub-blocks of the data block have been processed (compressed) and multiplexed 128 onto the transmission bit stream. Then, the operations are repeated again until all data blocks of the received portion of the audio signal have been processed (compressed) and multiplexed 128 onto the transmission bit stream.

Continuing to refer to FIG. 1, on selection, a prediction filter is applied 110 to the unit (block or sub-block)of audio data to be processed and compressed. Similar to the block/sub-block size information, the parameters of the prediction filter are conveyed 112-114 to the recipient (e.g. multiplexed 128 onto the transmission bit stream).

In various embodiments, the filtering may be assisted by the employment of neighboring blocks. In various embodiments, the prediction filter is a Linear Prediction Filter, and the parameters are the prediction order p, and the prediction coefficients a₁, . . . aₚ. Inv various embodiments, the parameters conveyed 112-114 to the recipient may include the prediction order p, the quantization step size use to quantize prediction coefficients, and the quantized prediction coefficients â₁, . . . , âₚ.

As illustrated, for the embodiments, as a result of the application of the prediction filter to the unit of audio data, residual samples e₁, . . . eₙ are generated 116. Next, a number of statistical measures are determined for the residual samples to characterize 118 their distribution (to be described more fully below). For the embodiment, the statistical measures are employed to form 120 a distribution descriptor (also to be described more fully below), which in turn is conveyed to the recipient (e.g. multiplexed onto the transmission bit stream). Further, for the embodiment, the statistical measures are employed to select 122 a distribution known to the recipient, and an identifier of the selected distribution is conveyed to the recipient (e.g. multiplexed 128 onto the transmission bit stream). In various embodiments, the distribution descriptor also serves as the identifier of the selected distribution. In particular, it is used as an index into an array of known distribution stored at the recipient.

In various embodiments, the statistical measures determined include a mean value of the residual samples, their variances, the skewness of their distribution, and the kurtosis of their distribution. In other embodiments, the invention may be practiced with more or less statistical measures.

Still referring to FIG. 1, for the embodiment, the determined statistical measures are also employed to divide each residual sample into two portions, a most significant bits (MSB) portion, and a least significant bit (LSB) portion (to be described more fully below). For the embodiments, the LSB of each residual sample is directly transmitted to the recipient (e.g., multiplexed 128 onto the transmission bit stream without encoding). For the embodiments, the number of LSB of each residual sample being directly transmitted to the recipient is also conveyed to the recipient (e.g., multiplexed 128 onto the transmission bit stream without encoding).

In various embodiments, the mean DC offset, if applicable, is also computed, and conveyed to the recipient (e.g., multiplexed 128 onto the transmission bit stream without encoding). For these embodiments, DC offset is subtracted from the residual samples.

Further, the MSBs of each residual sample are encoded 122-124 using codewords (or simply, codes) constructed using the selected distribution. The encoded MSBs are then provided to the recipient (e.g., multiplexed 128 onto the transmission bit stream without encoding). In various embodiments, the constructed codes may be Huffman codes, run length codes, adaptive arithmetic codes, non-adaptive arithmetic codes (e.g. Gilbert-Moore codes), or other codes of the like.

In the foregoing description, the conveyance to the recipient (e.g., multiplexed 128 onto the transmission bit stream) of the various values, block sizes, prediction order, quantization sizes, quantized prediction coefficients, distribution identifier, distribution descriptor, the number of LSB of each residual sample to be conveyed, the LSB, the encoded MSB, and so forth, are immediately described following the description of their generations. The order of presentation is merely for ease of understanding. The order of these descriptions is not to be read as limiting on the invention, requiring their conveyance on generation. The generated values may be stored, and processed into a transmission bit stream in batch. Further, multiple transmission bit stream, and/or multiple channels (of like or different kinds) may be employed for the transmission.

Referring now to the statistical measure determination 118, the LSB identification 126, and the MSB encoding 124 operations again, an embodiment of these operations will be described in further detail. Recall the received audio data are first partitioned 104 in to blocks or sub-blocks, and the blocks/sub-blocks are selected for processing, one block/sub-block at time. Assume the selected unit (block/sub-block) has a size of n, and the residual samples of this unit are e₁, . . . eₙ.

For the earlier described embodiment, where four statistical measures, the mean value of the residual sample, their variances, the skewness of the their distribution, and the kurtosis of their distribution, are computed, the computations are performed in accordance with the following formulas:

mean value of the residuals:

$$\overline{e} = \frac{1}{n} {\sum }_{i = 1}^{n} {x}_{i} ;$$

standard deviation of the residual's distribution: σ=\sqrt{var e}, where

$$var e = \frac{1}{n - 1} {\sum }_{i = 1}^{n} {( {e}_{i} - \overline{e} )}^{2} ;$$

skeweness of the distribution:

$$skew e = \frac{1}{n} {\sum }_{i = 1}^{n} {[ \frac{{e}_{i} - \overline{e}}{σ} ]}^{3} ;$$

and

kurtosis of the distribution:

$$kurt e = \frac{1}{n} {\sum }_{i = 1}^{n} {[ \frac{{e}_{i} - \overline{e}}{σ} ]}^{4} - 3.$$

Further, the distribution descriptor is formed as follows (with the quantized versions) of these quantities:

dsc=dsc(\overline{e}, log₂ σ, skew e, kurt e).

In alternate embodiments, e.g. embodiments offering low-complexity modes, kurt e=0; skew e=0; \overline{e}=0 instead of calculating them properly.

Further, in various alternate embodiments, parameter σ may be estimated by using absolute deviation or absolute mean of the residual:

$${σ}^{′} = {C}_{1} \frac{1}{n} {\sum }_{i = 1}^{n} \vert {e}_{i} - \overline{e} \vert \qquad ( a )$$

or

$${σ}^{″} = {C}_{1} \frac{1}{n} {\sum }_{i = 1}^{n} \vert {e}_{i} \vert \qquad ( b )$$

(under assumption that \overline{e}→0),

where C₁, is a constant chosen in view of the distribution (e.g. for zero mean Laplacian distribution, C₁ may be set to 1/sqrt(2)).

Further, in various embodiments, the distribution descriptor may be formed using

(i) only variance estimate (e.g. when mean=0) (optionally, using e.g. the (b) variance estimate approach described above),

(ii) variance+mean estimates (optionally, using e.g. the (c) variance estimate approach described above).

In various embodiments, on determination of the statistical measures, and selection of the distribution, an inverse-quantized mean value <\overline{e}>, and the logarithm of standard deviation log₂ σ of the distribution <log₂ σ> are reconstructed.

Then, the reconstructed values are employed to split each residual sample into MSB and LSB as follows:

eᵢ^{MSB}=(eᵢ−<\overline{e}>)>>max(<log₂ σ>−C₂, 0);

eᵢ^{LSB}=(eᵢ−<\overline{e}>)&((1<<max(<log₂ σ>−C₂, 0))−1);

where C₂ is an empirically selected constant. In various embodiments, C₂ is set to equal 3.

During decoding, each residual sample will be recombined as follows:

eᵢ=eᵢ^{MSB}<<max<log₂ σ>−C₂, 0))+eᵢ^{LSB}+<\overline{e}>.

where C₂ is an empirically selected constant. In various embodiments, C₂ is set to equal 3.

In various embodiments, the distribution descriptor is also the identifier of the selected distribution, as it indexes into an array of pre-stored distributions of the MSBs of the residual samples, at both the sender and the recipient.

In various embodiments, the ranges of MSBs in these pre-stored distributions are restricted to [−21,21], which approximately corresponds to the range of [−3σ,3σ] in the non-normalized distribution.

As described earlier, the selected distribution is used to construct block codes for encoding of the MSBs of the residual samples. Their LSBs will be transmitted directly using max (<log₂ σ>C₂, 0) bits for each residual sample. To encode samples which MSBs fall outside the [−\overline{e}{MSB}ₘₐₓ, \overline{e}{MSB}ₘₐₓ] range, for the embodiment, the encoder transmits an escape code (\overline{e}{MSB}ₘₐₓ+1), and then uses any standard monotonic code (e.g. Golomb codes, Golomb-Rice codes, Levenstein code, etc.) to transmit the difference |eᵢ^{MSB}| and the escape code.

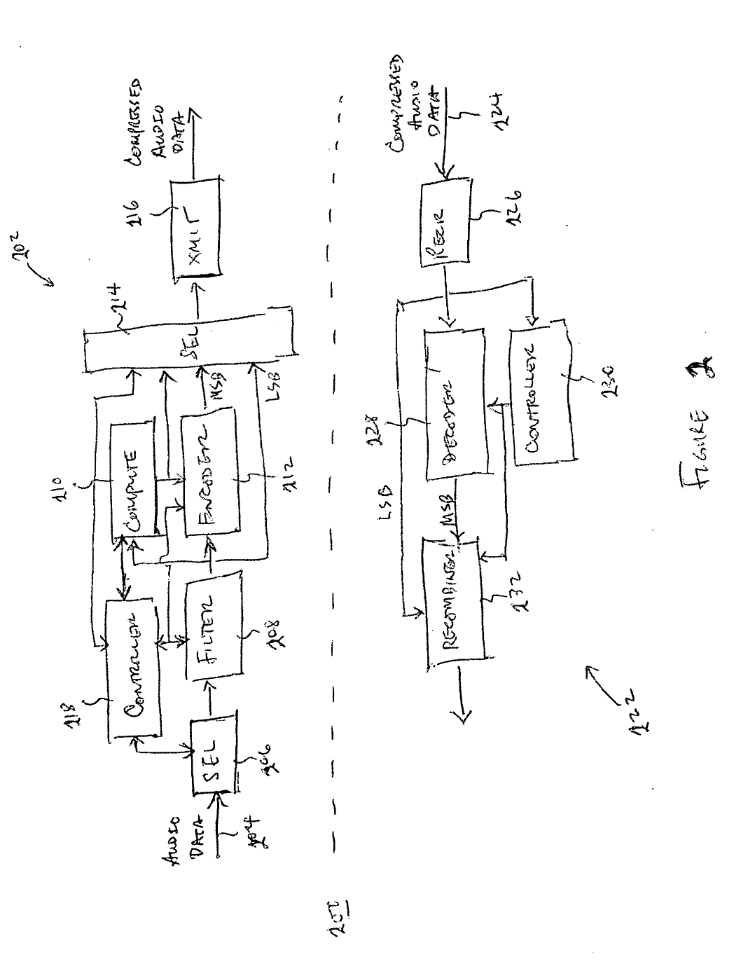

Referring now to FIG. 2, wherein a system having a transmit section and a receive section, both adapted to practice the compression method of FIG. 1, in accordance with some embodiments, is shown. In alternate embodiments, a system may comprise only the transmit section or the receive section. It is not necessary to always practice the invention with both sections.

As illustrated, for the embodiments, system 200 comprise transmit section 202 including transmitter 216, and a receive section 222 including receiver 226. In alternate embodiments, transmit and receive sections may share a common transceiver. Further, for the embodiments, in addition to transmitter 216, transmit section 202 includes controller 218, whereas in addition to receiver 226, receive section 222 includes controller 230, to control the operations of the various elements of the respective sections. Similarly, in alternate embodiments, transmit and receive sections may share a common controller instead.

For the embodiment, in addition to transmitter 216 and controller 218, transmit section 202 further includes first selector 206, filter 208, encoder 212, computer unit 210, and second selector 214, coupled to each other, and to transmitter 216 and controller 218 as shown. Selector 206 is employed, under the control of controller 218 to partition a portion of a stream of audio signal data into blocks or sub-blocks. Filter 208 is a prediction filter, to be applied, under the control of controller 218, to the current of audio signal data to be processed and compressed. Compute unit 210 under the control of controller 218 is employed to perform the various earlier described computations. Encoder 212 is employed under the control of controller 218 to encode the MSB of the residual samples as earlier described. Second selector 214 under the control of controller 218 is employed to select the various output values to be outputted, and multiplexed them onto the transmission bit stream.

For the embodiments, in addition to receiver 226 and controller 230, receive section 222 further includes decoder 228, and recombiner 232, coupled to each other, and to receiver 226 and controller 230 as shown. Decoder 228, under the control of controller 230, is employed to decode the encoded MSB of the residual samples as earlier described. Recombiner 232 is employed, under the control of controller 230, to recombine the received MSB and LSB to reconstitute the residual sample.

Except for the logic provided to these elements and/or their usage to cooperate with other elements to effectuate the desired compression of audio signal, these elements otherwise may be implemented in a variety of manners, in hardware, firmware, software, or combination thereof. Thus, system 200 represents a broad of range of systems having audio transmission and/or audio reception capabilities. For examples, system 200 may be a wireless mobile phone, a palm-sized computer, a tablet computer, a laptop computer, a desktop computer, a server, a set-top box, an audio/video entertainment unit, a music player, a DVD player, a CD player, a CAMCORDER, and so forth.

Thus, a novel audio signal data compression method and apparatus has been described. Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

What is claimed is:

1. A method comprising:
applying a prediction filter to a unit of audio signal data;
determining a distribution substantially representative of residual data generated as part of said applying of a prediction filter to the unit of audio signal data; and
transmitting in substance the unit of audio signal data to a recipient, utilizing the determined distribution to assist in reducing the amount of data having to be transmitted.

2. The method of claim 1, wherein the method further comprises
receiving a portion of a stream of audio signal data; and
partitioning the stream of the audio signal data into a plurality of units of audio data.

3. The method of claim 2, wherein the partitioning comprises partitioning the stream of the audio signal data into a plurality of fixed-size units of audio signal data.

4. The method of claim 2, wherein the method further comprises
selecting one of the plurality of units of audio signal data partitioned from the portion of the stream of audio signal data;
performing said applying, determining and transmitting operations of claim 1 for the selected unit of audio signal data; and
repeating the selecting and performing until all units of the partitioned audio signal data have been transmitted in substance to the recipient.

5. The method of claim 2, wherein the method further comprises
further partitioning the selected one of the first plurality of units of audio signal data into a second plurality of units of audio signal data;
selecting one of the second plurality of units of audio signal data;
performing said applying, determining and transmitting of claim 1 for the selected one of the second plurality of units of audio signal data; and
repeating the selecting of the second plurality of units of audio signal data, and the performing of said applying, determining and transmitting of claim 1 for the selected one of the second plurality of units of audio signal data, until all of the second plurality of units of audio signal data have been transmitted in substance to the recipient.

6. The method of claim 5, wherein the method further comprises repeating the further partitioning, the selecting, the performing, and the repeating of claim 5, until all of the first plurality of units of audio signal data have been transmitted in substance to the recipient.

7. The method of claim 1, wherein the method further comprises transmitting a plurality of parameters of the prediction filter to the recipient.

8. The method of claim 7, wherein
the applying comprises applying a linear prediction filter having a prediction order p, and prediction coefficients a₁, . . . , aₚ; and
the transmitting of the parameters of the prediction filter comprises transmitting the prediction order p, information about quantization step size used to quantize prediction coefficients, and quantized versions of the prediction coefficients a₁, . . . , aₚ.

9. The method of claim 1, wherein
the residual data comprises a plurality of residual samples;
the determining of a distribution comprises determining a plurality of statistical measures including a variance of the residual samples or an estimate of the variance;
forming a residual data distribution descriptor based at least in part on the determined variance of the residual samples or its estimate, the distribution descriptor identifying the substantially representative distribution to the recipient; and
the transmitting comprises transmitting the residual data distribution descriptor to the recipient.

10. The method of claim 9, wherein
the determining of the statistical measures further comprises determining a mean of the residual samples; and
the forming of the residual data distribution descriptor is further based on the determined mean of the residual samples.

11. The method of claim 9, wherein
the determining of the statistical measures further comprises determining at least a selected one of a skewness and a kurtosis of the residual samples; and
the forming of the residual data distribution descriptor is further based on the determined at least selected one of the skewness and the kurtosis of the residual samples.

12. The method of claim 1, wherein
the residual data comprises a plurality of residual samples;
the method further comprises determining a number of least significant bits (LSB) of each residual sample to be sent to the recipient; and
the transmitting comprises transmitting to the recipient how many LSB of each residual sample will be transmitted to the recipient and the appropriate number of LSB of each of the residual samples.

13. The method of claim 12, wherein the method further comprises determining a reconstructed inverse-quantized mean value of the residual samples, and the determining of the LSB of each residual sample to be sent to the recipient is performed based at least in part on the determined reconstructed inverse-quantized mean value of the residual samples.

14. The method of claim 1, wherein
the residual data comprises a plurality of residual samples, each having a plurality of data bits;
the method further comprises encoding the most significant bits (MSB) of each of the residual samples, employing codes constructed using the determined substantially representative distribution; and
the transmitting comprises transmitting the encoded MSB of the residual samples to the recipient.

15. The method of claim 14, wherein the method further comprises constructing the codes using the distribution, the constructed codes being Huffman codes.

16. The method of claim 14, wherein the method further comprises constructing the codes using the distribution, the constructed codes being run-length codes.

17. The method of claim 14, wherein the method further comprises constructing the codes using the distribution, the constructed codes being Gilbert-Moore codes.

18. The method of claim 14, wherein the method further comprises constructing the codes using the distribution, the constructed codes being arithmetic codes.

19. An apparatus comprising
a prediction filter;
a transmission unit; and
a control unit coupled to the prediction filter and the transmission unit, and adapted to apply the prediction filter to a unit of audio signal data to a recipient, and to use the transmission unit to transmit in substance the unit of audio signal data to the recipient, utilizing a distribution substantially representative of the residual data generated by the prediction filter to assist in reducing the amount of data having to be transmitted by the transmission unit.

20. The apparatus of claim 19, where the control unit is adapted to use the transmission unit to transmit a plurality of parameters of the prediction filter to the recipient.

21. The apparatus of claim 19, where the control unit is adapted to use the transmission unit to transmit a residual data distribution descriptor formed using at least some of a number statistical measures of the residual data, to the recipient, the distribution descriptor identifying the substantially representative distribution, and statistical measures are employed to identify the substantially representative distribution.

22. The apparatus of claim 19, wherein the apparatus further comprises a computation unit coupled to the prediction filter and the control unit, and adapted to compute at least a plurality of statistical measures for the residual data generated by the prediction filter.

23. The apparatus of claim 19, where the residual data comprises a plurality of residual samples having data bits, and the control unit is adapted to use the transmission unit to transmit a plurality of the least significant bits (LSB) of each of the residual sample, to the recipient, the LSB of each of the residual sample transmitted being determined based at least in part on the determined substantially representative distribution.

24. The apparatus of claim 19, where the residual data comprises a plurality of residual samples having data bits, and the control unit is adapted to use the transmission unit to transmit a plurality of codes, encoding the most significant bits (MSB) of each of the residual sample, to the recipient, the codes being constructed based at least in part on the determined substantially representative distribution of the residual samples.

25. The apparatus of claim 24, wherein the apparatus further comprises an encoder adapted to encode the MSB of each of the residual samples, using codes constructed from determined substantially representative distribution of the residual samples.

26. An apparatus comprising
a receiver unit;
a decoder coupled to the receiver unit; and
a control unit coupled to the receiver unit and the decoder, and adapted to use the decoder to recover a unit of audio signal data from an encoded transmission of the unit of audio signal received by the receiver unit, the encoded transmission included encoded most significant bits (MSB) and unencoded least significant bits (LSB) of residual samples of residual data generated by a prediction filter applied to the unit of audio signal data.

27. The apparatus of claim 26, wherein the encoded transmission further includes a distribution descriptor constructed based on statistical measures of the residual samples, and the control unit is further adapted to at least contribute in causing a inverse-quantized mean of the residual samples to be reconstructed.

28. The apparatus of claim 26, wherein the encoded transmission further includes a distribution descriptor constructed based on statistical measures of the residual samples, the distribution descriptor identifying the substantially representative distribution of the residual samples, and the control unit is further adapted to at least contribute in causing the substantially representative distribution to be available to the decoder for use to decode a plurality of codes received by the receiver unit, the codes encoding the MSB of the residual samples.

29. A system comprising:
a prediction filter;
a transmission unit;
a receiver unit;
a decoder unit; and
a control unit coupled to the prediction filter and the transmission unit, and adapted to apply the prediction filter to a first unit of audio signal data to a recipient, and to use the transmission unit to transmit in substance the first unit of audio signal data to the recipient, utilizing a distribution substantially representative of the residual data generated by the prediction filter to assist in reducing the amount of data having to be transmitted by the transmission unit, the control unit being further coupled to the receiver unit and the decoder unit, and adapted to use the decoder to recover a second unit of audio signal data from an encoded transmission of the second unit of audio signal received by the receiver unit, the encoded transmission included encoded most significant bits (MSB) and unencoded least significant bits (LSB) of residual samples of residual data generated by a prediction filter applied to the second unit of audio signal data.

30. The system of claim 29, further comprising a transceiver unit comprising the transmitter and receiver units.

31. The system of claim 29, further comprising an encoder unit coupled to the prediction filter and the transmission unit, to encode the MSB of the first unit of audio signal data, the MSB of the first unit of audio signal data being determined based at least in part on statistical measures of the residual samples generated by the prediction filter, when applied to the first unit of audio signal data.
